(19) United States
(12) Patent Application Publication
(10) Pub. No.: US 2009/0072516 A1
(43) Pub. Date: Mar. 19, 2009

(54) AUTOMATIC LOCKING TRAILER HITCH

(76) Inventor: Rainer Kuenzel, Hunt, TX (US)

Correspondence Address: C. JAMES BUSHMAN, 5851 San Felipe, SUITE 975, HOUSTON, TX, 77057, US

(21) Appl. No.: 12/212,914

(22) Filed: Sep. 18, 2008

Related U.S. Application Data
(60) Provisional application No. 60/994,287, filed on Sep. 19, 2007.

(51) Int. Cl. B60D 1/36

(52) U.S. Cl. 280/477

(57) ABSTRACT

An automatic locking trailer hitch comprising a housing having a first portion adapted to be connected to the tongue of a draft vehicle and a second portion forming a socket for receipt of a ball member, a trigger assembly responsive to a ball entering a socket to move a keeper assembly and a locking assembly to maintain said keeper assembly in a locked position relative to the ball.

### CROSS REFERENCE TO RELATED APPLICATION

This application claims the priority of U.S. Provisional Application No. 60/994,287 filed on Sep. 19, 2007, the disclosure of which is incorporated herein by reference for all purposes.

### BACKGROUND OF THE INVENTION

1. Field of the Invention

The present invention relates to a trailer hitch and, more specifically, to an automatic locking trailer hitch.

2. Description of the Prior Art

The prior art abounds with numerous types of trailer coupling for detachably connecting a trailer or the like to a draft vehicle such as an automobile. Most commonly used trailer couplings comprise a ball member attached to the rear structure of the draft vehicle and a socket forming structure attached to the tongue of a pulled vehicle e.g. a trailer. In order to permit the trailer to be readily detached from the drive vehicle, it is common practice to provide a latch on the socket forming structure which is manually movable to engage the ball member and to latch the ball member in place in the socket but is likewise releasable whenever disconnection of the trailer from the draft vehicle is desired.

While the prior art ball and socket couplings are satisfactory in actual use when the ball locking latch has been properly manipulated, it frequently happens that the users forget to activate the latch into a final locking position. When this occurs, the latch may merely loosely connect the ball member and the socket. While this will usually prevent separation of the ball from the socket while the trailer is advancing over a relatively smooth pavement, when travelling over rough terrain or with sufficient relative vertical movement between the trailer and the draft vehicle, the looseness can result in the ball leaving the socket with the result that the draft vehicle and the trailer are disconnected, often with disastrous results.

Numerous automatic locking trailer hitches have been proposed as, for example, in U.S. Pat. No. 2,855,222.

### SUMMARY OF THE INVENTION

In one aspect the present invention provides an automatic trailer hitch comprising a housing having a portion attachable to the tongue or other structure of a draft vehicle, the housing forming a socket for receipt of the ball member mounted on the tongue of a trailer to be pulled; a keeper for maintaining the ball in the socket, i.e., in an engaged position; a trigger for setting the keeper in the engaged position and; a selectively releasable lock for holding the keeper in the engaged position.

The foregoing objects, features and advantages of the present invention, as well as others, will be more fully understood and better appreciated by reference to the following drawings, specification and claims.

### BRIEF DESCRIPTION OF THE DRAWINGS

FIG. 1 is a side, elevational view, partly in sections, showing one embodiment of the locking trailer hitch of the present invention.

FIG. 2 is a view taken along the lines 2-2 of FIG. 1.

FIG. 3 is a view taken along the lines 3-3 of FIG. 1.

FIG. 4 is a bottom plan view of the trailer hitch shown in FIG. 1.

FIG. 5 is a view similar to FIG. 1 showing the trailer hitch of the present invention in the open position.

FIG. 6 is a partial, top view of the trailer hitch of the present invention.

FIG. 7 is a partial, side view, partly in section, showing an alternative embodiment of the present invention.

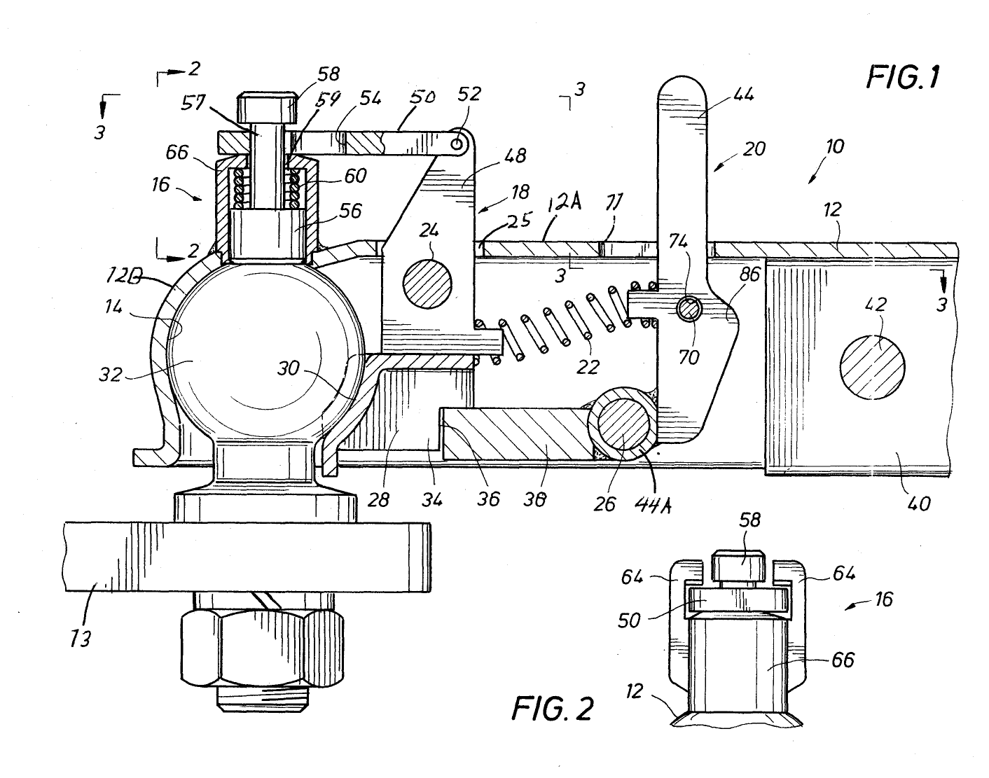

### DETAILED DESCRIPTION OF PREFERRED EMBODIMENTS

Reference is made to FIG. 1 which shows the automatic trailer hitch of the present invention in the locked or engaged position, the trailer hitch, shown generally as 10, comprises a housing 12 having a first portion 12A forming an elongate channel for engaging the tongue 40 of a draft vehicle, housing portion 12A being connected to tongue 40 by means of a bolt 42 extending through registering holes in tongue 40 and housing portion 12A. Housing 12 also includes a socket forming portion 12B forming a socket 14 for receipt of a ball 32 attached in the well known manner to the tongue 13 of a trailer. Housing portion 12A has a slot 11B in the top surface, the bottom of housing 12 being open. Extending through slot 11 B out of housing 12 is the lever 44 of a lock assembly shown generally as 20. Lever 44 is secured to a sleeve 44A which is rotatable around a pivot pin 26 thereby pivotally mounting lever 44 in housing 12. Locking mechanism 20 further includes a stop 38 by a bar like structure which also is secured to sleeve 44A. Thus, stop 38, like lever 44, are pivotally mounted around pivot pin 26 for simultaneous movement.

A keeper mechanism shown generally as 18 comprises an arm 48 which is secured at its lower end to a frame 28 having a pair of spaced apart legs 34, legs 34 forming a pair of stop shoulders 36. Frame 28 further has a concave ball engaging surface 30. Arm 48 is pivotally mounted in housing 12 by means of a pivot pin 24 and extends through a slot 25 in housing portion 12A. A compression spring 22 has one end connected to lever 44 and the other end to arm 48 of keeper mechanism 18.

A triggering device shown generally as 16 comprises a piston housing 66 which is secured to housing portion 12B, housing 66 defining a chamber in open communication with socket 14. Disposed in piston housing 66 is a piston 56 which is connected to a piston rod 57, a compression spring 60 being in surrounding relation to piston rod 57, spring 60 being trapped between piston 56 and the upper wall of housing 66. Piston rod 57 extends through an opening 59 in the upper wall of piston housing 66 and is connected to a piston head 58.

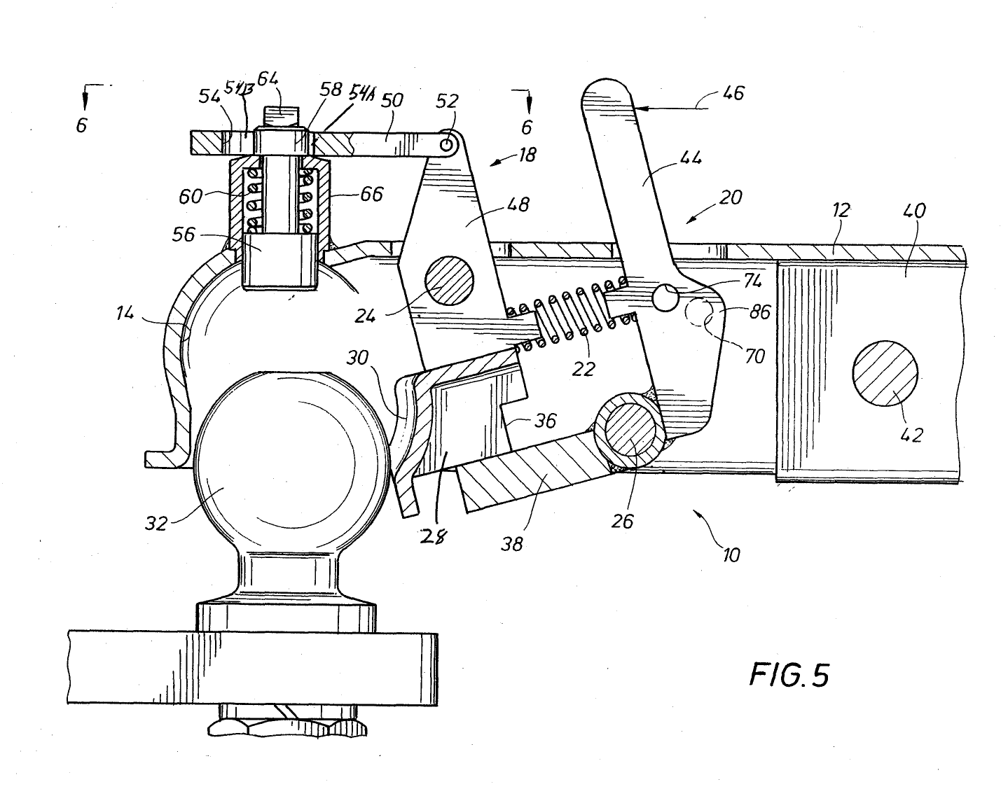

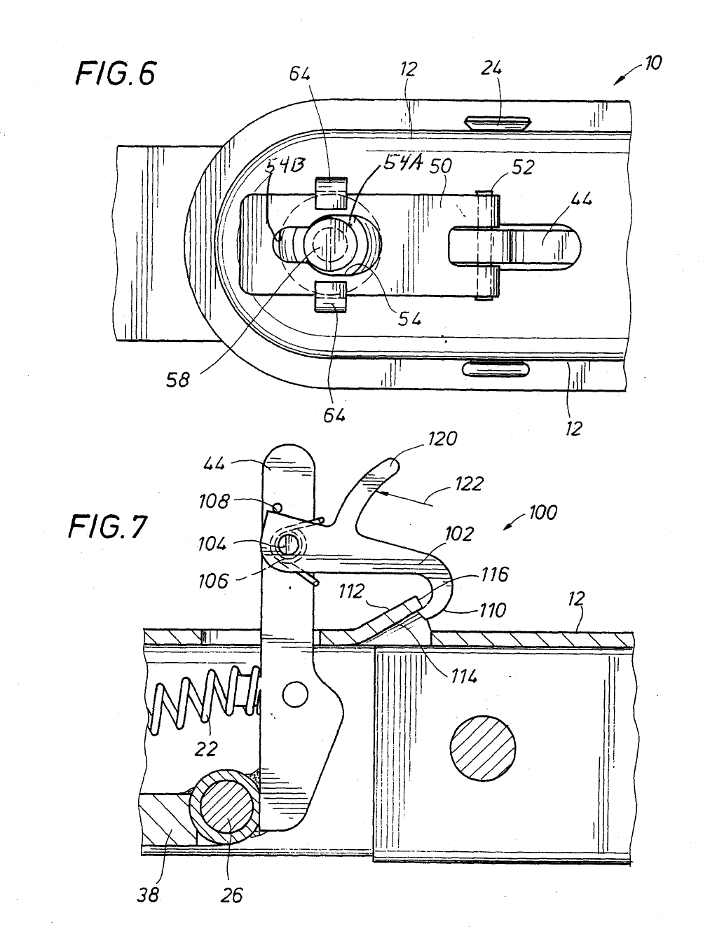

A slide plate 50 is pivotally connected as at 52 to arm 48 and has a keyhole opening 54 comprised, as shown in FIG. 6, of an enlarged area portion 54A and a reduced area portion 54B. As best seen by comparison of FIGS. 1 and 5, slide plate 50 is movable between a first position (FIG. 1) wherein piston head 58 is in register with the reduced area portion 54B of keyhole 54 to a second position (FIG. 5) wherein piston head 58 is in register with the enlarged area portion 54A of keyhole 54. As seen in FIG. 1, when ball 32 is received in socket 14, piston 56 is engaged by ball 32 compressing spring 60 in piston housing 66 and piston head 58 is in register with the reduced area portion 54B of keyhole 54. As piston head 58 has a larger diameter or size than reduced area portion 54B, in the position shown in FIG. 1, piston head 58 cannot move downwardly through keyhole 54. Further, in the position shown in FIG. 1, concave surface 30 has engaged ball 32 preventing any movement of ball 32 out of socket 14.

In the latched or locked position shown in FIG. 1, ball 32 cannot dislodge from socket 14 because stop surfaces 36 on frame 28 have engaged stop 38 precluding any movement of concave surface 30 away from ball 32. In the event that extra safety is desired, lever 44 can be locked in position by means of a safety pin 70 received in a hole 74 in lever 44 and registering holes 72 in housing 12.

It will be appreciated that if due to uneven terrain conditions during travel, relative vertical movement occurs between tongues 40 and 13, ball 32 will exert force against concave surface 30 attempting to force arm 48 to move in a counterclockwise direction around pivot pin 24. However, as noted such movement is precluded by engagement between stop surface 36 and stop 38.

With reference now to FIG. 5 which shows the trailer hitch of the present invention in the ready or open position, i.e., before ball 32 has been fully received in socket 14, it can be seen that slide plate 50 has been moved to the position where enlarged portion 54A of keyhole 54 is in register with piston head 58. Since piston head 58 is of a smaller diameter or area than the area of enlarged portion 54A, it has been pulled downwardly, i.e., in the direction of socket 14, by the action of spring 60 forcing piston 56 into socket 14. As can also be seen, the manual movement of lever 44 in the direction of arrow 46 to permit release of ball 32 from socket 14 tilts stop bar 38 downwardly out of engagement with stop shoulders 36 such that frame 28 can now move to a disengaged position relative to ball 32 allowing ball 32 to exit or enter socket 14. The tilting of stop 38 results in disengagement of shoulders 36 with stop 38 thereby permitting frame 28 to move away from socket 14. It will be noted that arm 48 has also been pivoted around pin 24 towards lever 44 further compressing spring 22.

When ball 32 is completely out of socket 14, spring 22 is unable to rotate lever 44 back into the latched or closed position of FIG. 1 because piston head 58 is now in enlarged portion 54A of keyhole 54 meaning that slide plate 50 is substantially precluded from horizontal movement e.g. to the right as best seen with reference to FIG. 6.

When it is desired to connect ball 32 to the trailer hitch of the present invention, ball 32 enters cavity 14 where it engages piston 56 compressing piston 16 and moving head 58 out of the enlarged portion 54A of keyhole 54. Thus plate 50 can now slide to the right putting head 58 in register with the reduced area portion 54B of keyhole 54. In response, spring 22 rotates arm 48 of keeper 18 in a clockwise direction thereby moving concave face 30 of frame 28 toward socket 14. As ball 32 completely enters socket 14, spring 22 can now fully expand allowing arm 48 to rotate clockwise to the point where block 38 is once again engaged by stop shoulders 36. At such time that piston 56 moves upwards and piston head 58 exits keyhole 54, slide plate 50 will be kept down by keepers or dogs 64 attached to the side of piston housing 66.

As noted above, to ensure that when the draft vehicle and the trailer are attached, and as an additional safety measure, pin 70 can be inserted through holes 72 and 74 to ensure that the mechanism remains locked under all circumstances.

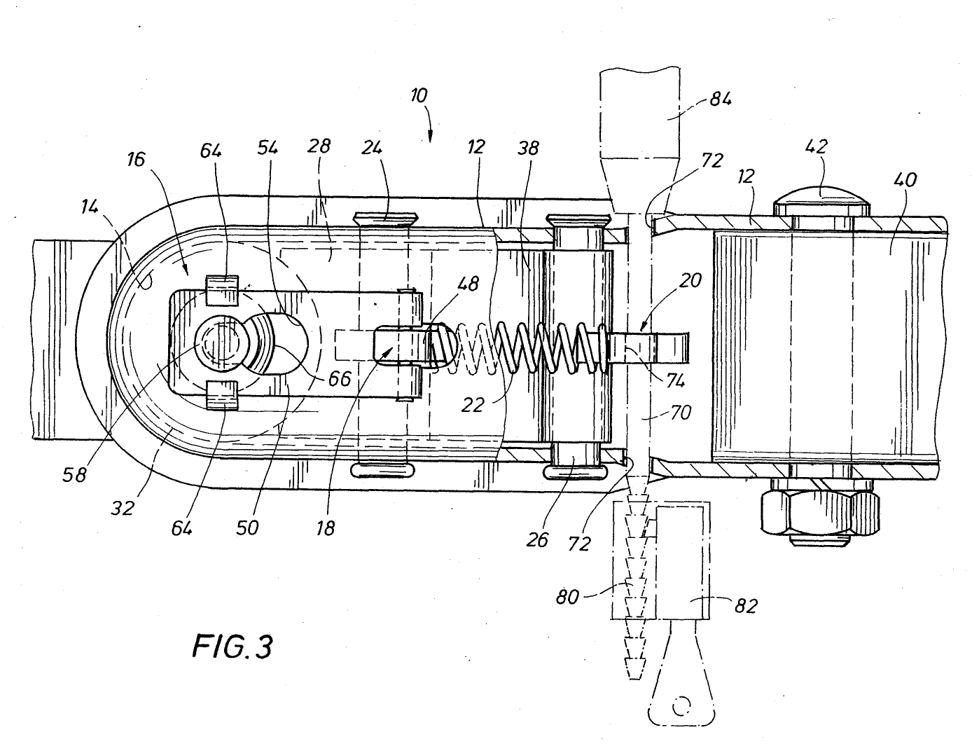

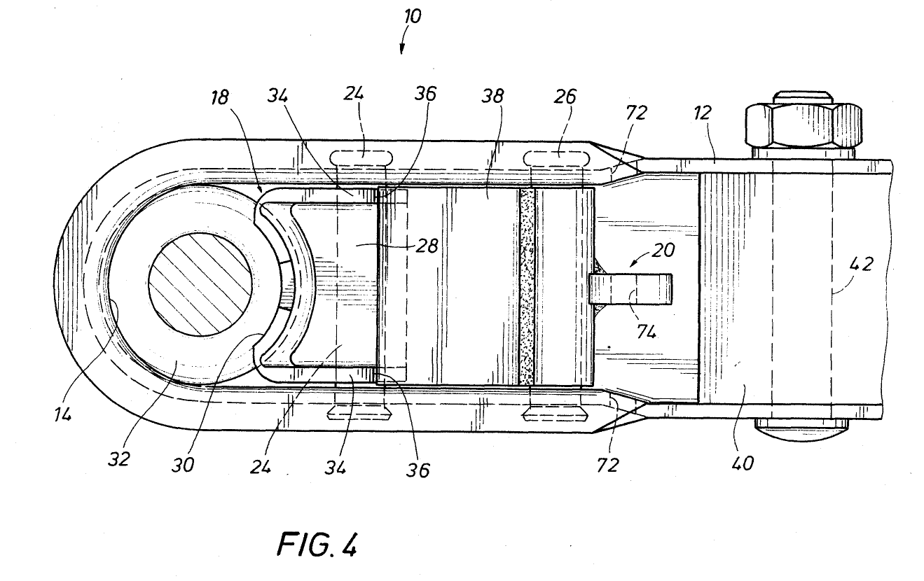

Instead of a simple pin, a special locking pin as shown in FIG. 3 can be employed. In this regard, pin 80, shown in phantom, can be provided with a key operated lock 82 which is slid over a serrated portion of pin 80 in racket-like fashion until enlarged portion 72 of pin 80 is pulled against housing 12 around hole 72 at which point lock 82 can be locked by locking lock 82.

Pin 80 can also be provided with a signal emitting mechanism or alarm 84 which will only stop when the pin is installed indicating a secure hitch. In this regard to prevent installation of pin 80 into an open, unsecured hitch, holes 72 of housing 12 can be blocked by a protrusion 86 (see FIG. 5) on lever 44 when the hitch is in the open position.

FIG. 7 shows an alternate locking device, indicated as 100, that can be used to ensure that lever 44 remains in its locked position. A hook 102 is pivotally attached to lever 44 by means of a pivot pin 104 which is urged into clockwise rotation by a torque spring 106, hook 102 engaging stop pin 108 on lever 44. During the hitching process, it will be seen that the distal end 110 of hook 102 slides up on a ramp 112 of an upward facing protrusion 114 of housing 12 and drops into engagement under the edge 116 of protrusion 114 thereby preventing accidental counterclockwise rotation of lever 44. During the disengagement process, thumb pressure against extension 120 of hook 102 in the direction of arrow 122 results in counterclockwise rotation of hook 102 moving end 110 out from under edge 116 which permits counterclockwise rotation of lever 44.

The foregoing description and examples illustrate selected embodiments of the present invention. In light thereof, variations and modifications will be suggested to one skilled in the art, all of which are in the spirit and purview of this invention.

What is claimed is:

1. An automatic locking trailer hitch comprising:
a main housing, said main housing having a first portion adapted to be connected to the tongue of a draft vehicle and a second portion distal said first portion forming a socket for receipt of a ball member;
a lever rotatably journalled in said housing;
a stop attached to said lever and rotatable therewith;
a keeper rotatably journalled in said housing, said keeper including a surface for engaging said stop when said lever and said keeper are in a first position, said keeper further including a ball engaging surface;
a spring connected to said keeper and said lever, said spring urging said lever and said keeper into a position for clockwise rotation;
a slide plate pivotally connected to said keeper, said slide plate having a keyhole opening and being slidable in response to movement of said keeper by said spring;
a piston housing secured to said main housing, said piston housing being in open communication with said socket;
a piston mounted in said piston housing, said piston having a piston head, a piston rod and a piston lug;
a biasing member urging said piston towards said socket, said piston rod being extendable through said keyhole, said lug being connected to said piston rod distal said piston, said keyhole having an enlarged area portion allowing downward movement of said piston lug into said keyhole when said piston lug is in register with said enlarged area portion, and a reduced area portion preventing downward movement of said piston lug into said keyhole when said lug is in register with said reduced area portion, said plate being slidable between a first position wherein said piston lug is in register with said enlarged area portion and a second position wherein said lug is in register with said reduced area portion.

2. An automatic trailing locking hitch comprising:
a housing having a first portion adapted to be connected to the tongue of a draft vehicle and a second portion forming a socket for receiving a ball member;
a keeper assembly movable between a first position wherein said ball is locked in said socket and a second position wherein said ball can be removed from said socket;
a biasing member selectively maintaining said keeper assembly in said second position;
a trigger assembly operatively connected to said keeper assembly for controlling release of said keeper assembly from said second position when said ball is received into said socket;
a selectively releasable locking assembly for maintaining said keeper assembly in said first position, said locking assembly being selectively movable to a release position wherein said biasing member can move said keeper to said second position and permit movement of said ball out of said socket.
